(19) United States
(12) Patent Application Publication
(10) Pub. No.: US 2026/0009938 A1
(43) Pub. Date: Jan. 8, 2026

(54) COLOR FILTER

(71) Applicants: Lite-On Singapore PTE. LTD., Singapore (SG); Singapore University of Technology and Design, Singapore (SG)

(72) Inventors: Rui-Tao Zheng, Singapore (SG); Sin-Heng Lim, Singapore (SG); Srinivasan Lakshmanan Chettiar, Singapore (SG); Wei-Xian Choo, Singapore (SG); Tse Hui Dawn Tan, Singapore (SG); Hong-wei Gao, Malaysia (MY)

(21) Appl. No.: 18/764,353

(22) Filed: Jul. 4, 2024

(51) Int. Cl. G02B 5/26

(52) U.S. Cl. CPC G02B 5/26

(57) ABSTRACT

A color filter is provided. The color filter includes a substrate, a first reflective layer, a patterned color layer, and a second reflective layer. The first reflective layer is disposed on the substrate. The patterned color layer is disposed on the first reflective layer, the patterned color layer includes a plurality of color patterns having a first thickness, and each of the color patterns includes a porous structure having a plurality of holes spaced from one another. The second reflective layer is disposed on the patterned color layer. The porous structure includes a first material, the plurality of holes are filled with a second material, the first material has a first refractive index, and the second material has a second refractive index different from the first refractive index. Any neighboring two of the color patterns differ from each other in a hole radius or a pitch.

### FIELD OF THE DISCLOSURE

The present disclosure relates to an optical element, and more particularly to a nanostructured color filter for an image sensor.

### BACKGROUND OF THE DISCLOSURE

In the related art, due to the different physical properties required for different colors, designing a color filter with the same or similar dielectric thickness across various color spectra may be difficult.

Furthermore, manufacturing processes for creating the color filter involves the use of multiple masks, which significantly increases the complexity of the procedure. This multi-mask method, while necessary for achieving desired filter properties, introduces numerous steps and potential points of error, thereby complicating the overall process. In addition, the overhead costs of the manufacturing process, including the cost of materials, labor, and equipment, are significant.

### SUMMARY OF THE DISCLOSURE

In response to the above-referenced technical inadequacies, the present disclosure provides a nanostructured color filter for an image sensor capable of reducing the complexity of the manufacturing process.

In order to solve the above-mentioned problems, one of the technical aspects adopted by the present disclosure is to provide a color filter, which includes a substrate, a first reflective layer, a patterned color layer, and a second reflective layer. The first reflective layer is disposed on the substrate. The patterned color layer is disposed on the first reflective layer, the patterned color layer includes a plurality of color patterns having a first thickness, and each of the color patterns includes a porous structure having a plurality of holes spaced from one another. The second reflective layer is disposed on the patterned color layer. The porous structure includes a first material, the plurality of holes are filled with a second material, wherein hole dimensions of the plurality the color patterns are different from one another.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a side view of a color filter according to the first embodiment of the present disclosure;

FIG. 2 is a cross-sectional view taken along line A-A of FIG. 1;

FIG. 3 shows transmission spectra obtained by using an exemplary structure of the color filter according to the first embodiment of the present disclosure;

FIG. 4 is a side view of a color filter according to the second embodiment of the present disclosure;

FIG. 5 is a cross-sectional view taken along line B-B of FIG. 4;

FIG. 6 is a side view of another color filter according to the second embodiment of the present disclosure;

FIGS. 7-10 shows first, second, third and fourth transmission spectra obtained by using a first, second, third and fourth exemplary structure of the color filter according to the second embodiment of the present disclosure individually;

FIG. 11 is a side view of a color filter according to the third embodiment of the present disclosure;

FIG. 12 is a cross-sectional view taken along line C-C of FIG. 11;

FIG. 13 shows reflection spectra obtained by measuring reflectance of the color filters according to the third embodiment of the present disclosure; and

FIGS. 14A to 14C show reflection spectra of the color filter covering 450 nm to 600 nm according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In the present disclosure, the term “color filter” refers to an optical element that changes the nature or color of light that passes through the color filter. For example, the term “color filter” can refer to a structure that filters light by reflecting or absorbing at least a portion of some of the frequencies of the light and transmitting at least a portion of some of the frequencies of the light.

One object of the present disclosure is to provide a color filter that allows structures which utilize the same (or similar) dielectric thickness to be used for the various color spectra, thus reducing the complexity of the manufacturing process, allowing the number of mask steps to be substantially reduced, and greatly reducing process overhead and cost.

### First Embodiment

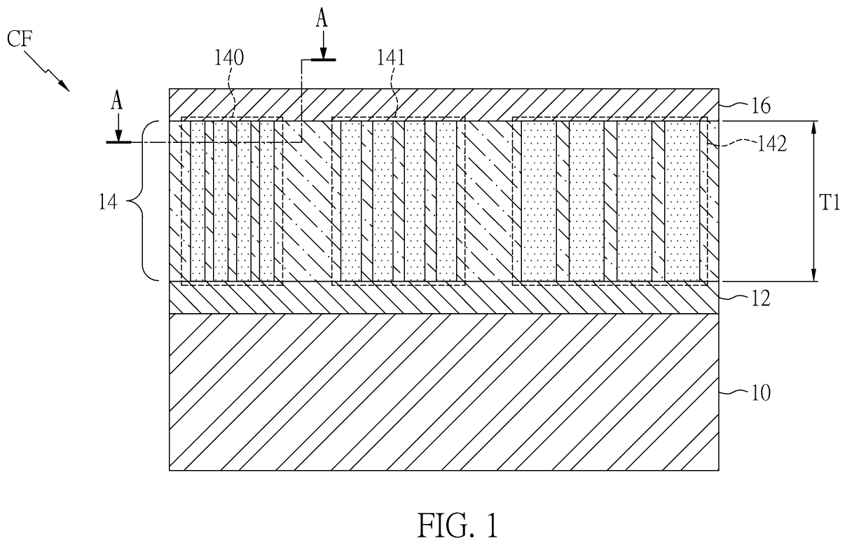

FIG. 1 is a side view of a color filter according to the first embodiment of the present disclosure. Referring to FIG. 1, a first embodiment of the present disclosure provides a color filter CF, which includes a substrate 10, a first reflective layer 12, a patterned color layer 14, and a second reflective layer 16.

The substrate 10 can be made of a semiconductor material, such as silicon, silicon nitride, and the like. In some embodiments, a thickness of the substrate 10 can range from 200 to 800 μm.

The first reflective layer 12 is disposed on the substrate 10 to serve as a bottom reflector and the second reflective layer 16 is disposed on the patterned color layer 14, to serve as a top reflector. The first reflective layer 12 and the second reflective layer 16 can be made of a metal material with high reflectivity, such as silver. In some embodiments, a thickness of the first reflective layer 12 and a thickness of the second reflective layer 16 can be designed according to color spectra of the color filter CF. For example, the thickness of the first reflective layer 12 and the second reflective layer 16 can range from several nanometers to tens of nanometers, preferably from 5 nm to 30 nm and the present disclosure is not limited thereto. In this embodiment, the first reflective layer 12 and the second reflective layer 16 preferably have the identical thicknesses, which range from 15 nm to 25 nm.

The patterned color layer 14 is disposed on the first reflective layer 12, the patterned color layer 14 can include color patterns 140, 141 and 142 having the same thickness T1, and each of the color patterns 140, 141 and 142 includes a porous structure having a plurality of holes H1 spaced from one another. In some embodiments, the second reflective layer 16 can disposed on the top of the corresponding color patterns 140, 141 and 142 only. That is, the second reflective layer 16 can be divided into a plurality of second reflective parts with similar shape of the corresponding the color patterns 140, 141 and 142.

The first reflective layer 12 and the second reflective layer 16 can be made of the same or different metal materials. Using different metal materials and thicknesses to fabricate the first reflective layer 12 and the second reflective layer 16 can change the transmittance of the color filter CF for lights with different wavelengths. That is, for different transmission spectra, different metals can be used to fabricate the first reflective layer 12 and the second reflective layer 16.

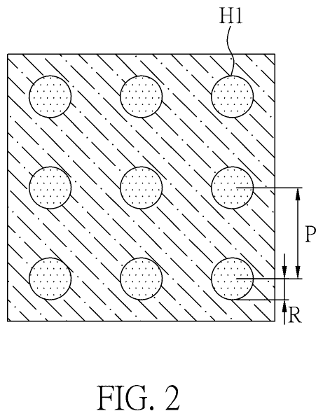

Reference can be made to FIG. 2, which is a cross-sectional view taken along line A-A of FIG. 1. As shown in FIG. 2, a plurality of holes H1 are formed to penetrate the porous structure that is made of a first material, and a second material can be filled into each of the holes H1, and the first material has a refractive index that is larger than a refractive index of the second material. The plurality of holes H1 can be arranged in a 3*3 matrix, however, the present disclosure is not limited thereto. In other embodiments, the holes H1 can be arranged in a polygon shape, such as a hexagonal shape.

In the present embodiment, the color patterns 140, 141, 142 correspond to multiple colors of lights with different wavelengths. That is, the color patterns 140, 141 and 142 correspond to transmission spectra with different peak wavelengths. Each of the peak wavelengths can be adjusted by changing hole dimensions of the color pattern. For example, the hole dimensions can include a hole radius R and a pitch P among the neighboring holes H1 (or can be referred to as a hole distance), and any neighboring two of the color patterns 140, 141 and 142 differ from each other in the hole radius R or the pitch P.

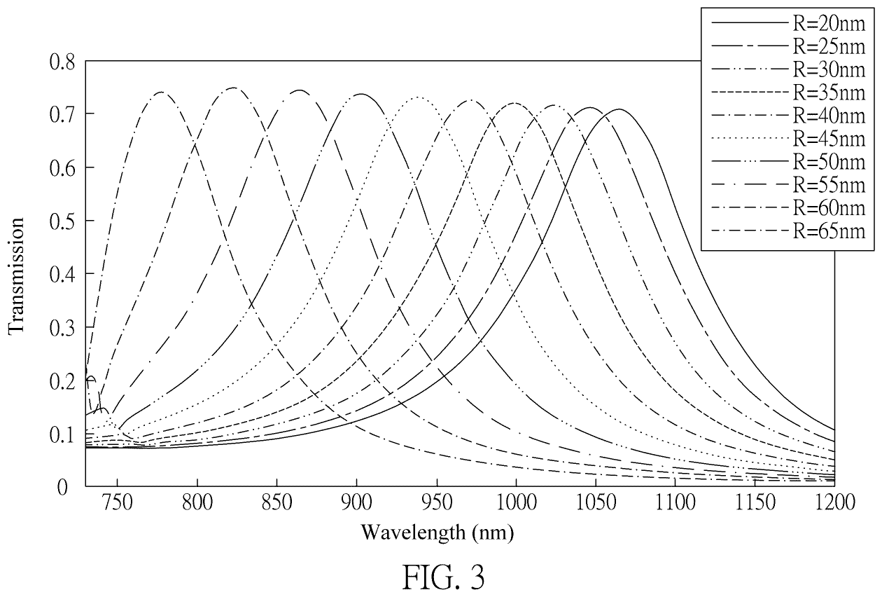

Reference can be made to FIG. 3, which shows transmission spectra obtained by using an exemplary structure of the color filter according to the first embodiment of the present disclosure. In the exemplary structure of the color filter CF, the patterned color layer 14 with only one of the color patterns 140, 141 and 142 is utilized for simulation, in which the thickness T1 of the patterned color layer 14 and the pitch P are 170 nm and 160 nm, respectively. Furthermore, the first reflective layer 12 and the second reflective layer 16 are silver layers having the same thickness, e.g., 18 nm, and the substrate 10 is made of Si₃N₄. Furthermore, the porous structure of the patterned color layer 14 is made of silicon oxide, and the holes H1 are cylindrical holes filled with air, thereby a refractive index of the porous structure being larger than a refractive index of the material filled in the holes H1.

In a simulation scenario, an upper surface of the second reflective layer 16 serves as an incident surface and a lower surface of the substrate 10 serves as a transmission surface, that is, a surface of the second reflective layer 16 without disposing the patterned color layer is a light-incident surface, and a surface of the substrate 10 without disposing the first reflective layer 12 is a light-transmitted surface, and the light is incident from the light-incident surface. As can been seen from FIG. 3, as the hole radius R increases from 20 nm to 65 nm, a peak wavelength of each of the spectra decreases from 1080 nm to 770 nm (i.e., blue-shifted). Therefore, the peak wavelength can be adjusted by changing the hole radius R of the hole H1. In the present embodiment, when the thickness T1 of the patterned color layer (or the color patterns) ranges from 140 nm to 200 nm, the hole radius R ranges from 10 nm to 80 nm, and the pitch P ranges from 140 nm to 200 nm, the wavelength peaks of the transmission spectra of the color filter CF can range from 700 nm to 1150 nm. Moreover, the hole radius R of the color patterns of the patterned color layer is smaller, the wavelength of the transmission spectra of the color patterns of the color filter CF will be lager. The hole radius R of one of the color patterns is negative proportional to corresponding wavelength of the transmission spectra of the one of the color patterns.

That is, by using different hole dimensions in the color patterns, it is possible to provide light filtering structures corresponding to different colors without changing the thickness of the patterned color layer 14. Furthermore, although the pitch P is fixed in the present embodiment, the color patterns corresponding to different colors can differ from one another in the pitch P, so as to adjust the wavelength peaks of the transmission spectra of the color filter CF.

Therefore, unlike existing technologies, the color filter provided by the present disclosure can be fabricated without using multiple mask processes, which can reduce the number of process steps and thus reduce costs and process complexity.

However, the aforementioned details are disclosed for exemplary purposes only, and are not meant to limit the scope of the present disclosure.

### Second Embodiment

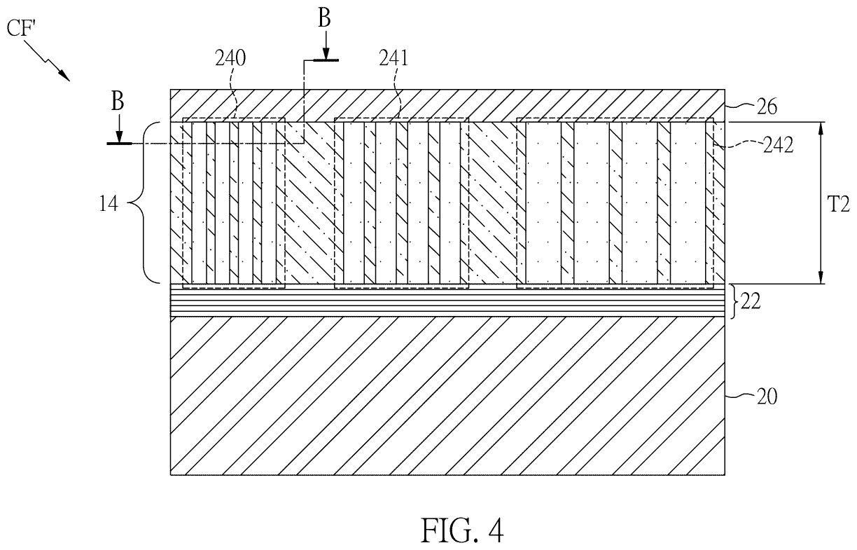

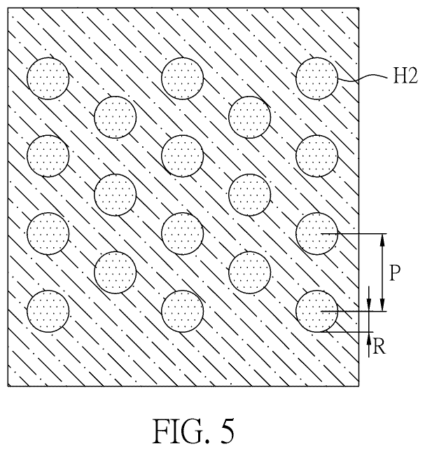

FIG. 4 is a side view of a color filter according to the second embodiment of the present disclosure, and FIG. 5 is a cross-sectional view taken along line B-B of FIG. 4. Referring to FIGS. 4 and 5, a second embodiment of the present disclosure provides a color filter CF′ suitable for the visible lights and the near-infrared lights, the color filter CF′ includes a substrate 20, a first reflective layer 22, a patterned color layer 24, and a second reflective layer 26.

The first reflective layer 22 is disposed on the substrate 20, and the patterned color layer 24 is disposed on the first reflective layer 12, the patterned color layer 24 can include color patterns 240, 241 and 242 having the same thickness T2, and each of the color patterns 140, 141 and 142 includes a porous structure having a plurality of holes H1 spaced from one another.

Comparing FIG. 4 with FIG. 1, and comparing FIG. 5 with FIG. 3, the main difference between the second embodiment and the first embodiment is as follows: the first reflective layer 22 is a distributed Bragg reflector (DBR) layer, the porous structure of the patterned color layer 14 is made of silicon nitride, and the holes H2 are arranged in a hexagonal shape and filled with silicon oxide.

In more detail, the first reflective layer 22 is a DBR layer that includes a plurality of pairs of a first layer and a second layer with different refractive indices. Similarly, the second reflective layer 26 can be made of a metal material, such as silver. By replacing the first reflective layer 12 with the DBR layer, an intensity of the transmitted light can be increased, and a full width at half maximum (FWHM) of the transmission spectra of the color filter CF′ can be decreased. In some embodiments, the number of the pairs of the first layer and the second layer included in the first distributed Bragg reflector layer ranges from 2 to 5. The first layer and the second layer of the DBR layer can be fabricated using a variety of materials, depending on the specific application and requirements, such as gallium nitride (GaN), gallium oxide (Ga₂O₃), gallium arsenide (GaAs), aluminum arsenide (AlAs), and the like.

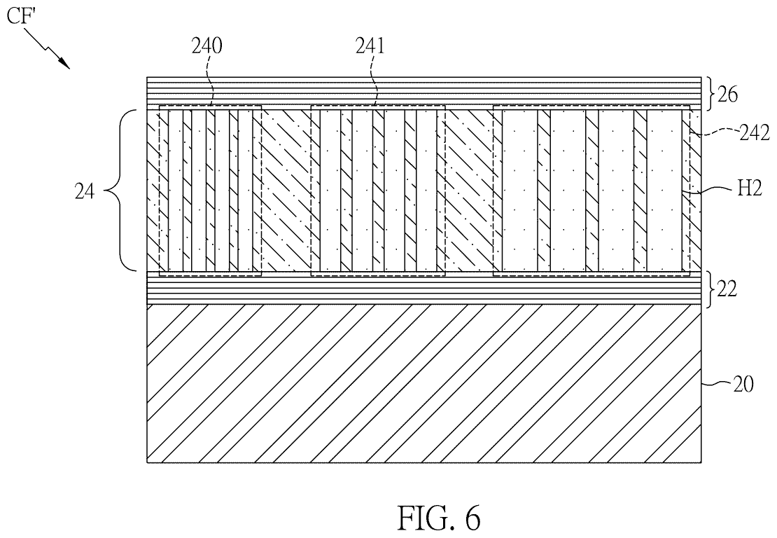

Comparing FIG. 6 with FIG. 4, the second reflective layer 26 is replaced by another DBR layer that is similar to the first reflective layer 22.

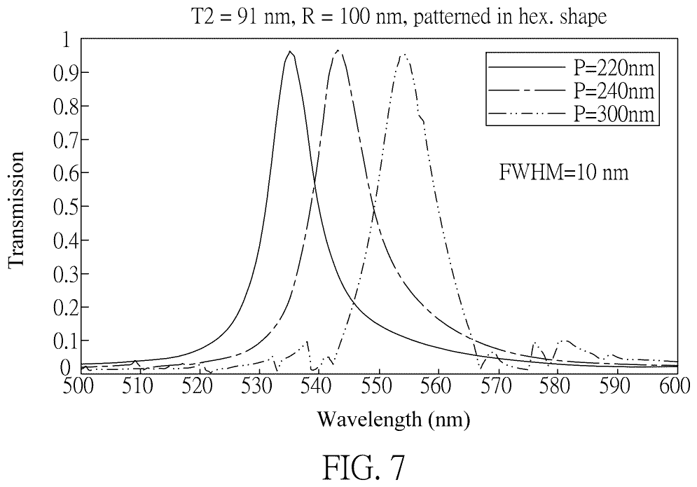

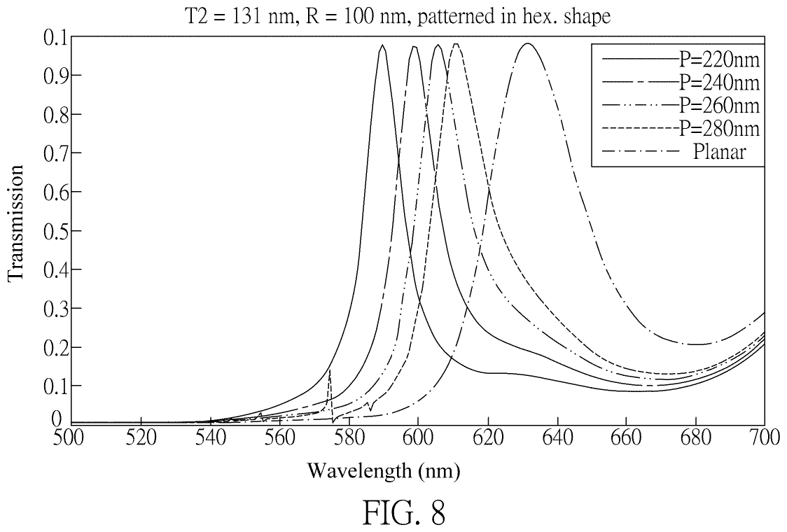

Reference can be made to FIGS. 7 and 8, which shows first and second transmission spectra respectively obtained by using first and second exemplary structures of the color filter according to the second embodiment of the present disclosure. In the first and the second exemplary structures of the color filter CF′, the patterned color layer 24 with only one of the color patterns 240, 241 and 242 is utilized for simulation, in which the thickness T2 of the patterned color layer 24 are 91 nm and 131 nm, respectively. Furthermore, the first reflective layer 22 and the second reflective layer 26 are DBR layers having the same thickness, e.g., 300-500 nm, and the substrate 20 is made of Si₃N₄. Furthermore, the porous structure of the patterned color layer 24 is made of silicon nitride (Si₃N₄), and the holes H2 are cylindrical holes filled with silicon oxide, thereby a refractive index of the porous structure being larger than a refractive index of the material filled in the holes H2, and the hole radius R can be 100 nm, preferably.

In a simulation scenario of FIG. 7, a light is incident from the upper surface of the second reflective layer 26. As can been seen from FIG. 7, as the pitch P increases from 220 nm to 300 nm, a peak wavelength of each of the spectra increases from 532 nm to 555 nm (i.e., red-shifted), and the transmission spectra of FIG. 7 cover a wavelength range from 500 nm to 600 nm. Moreover, since the DBR layers are utilized in the present embodiment, FWHM can be decreased to about 10 nm, thereby enabling the color filter CF′ to be more selective, so as to achieve higher color purity.

As can been seen from FIG. 8, as the pitch P increases from 220 nm to 280 nm, and a peak wavelength of each of the spectra increases from 582 nm to 610 nm (i.e., red-shifted). The patterned color layer 24 also can further include at least one planar color pattern, wherein there is no nanohole or porous structure existing in the planer color pattern. In the present embodiment, the porous structure and the planar color pattern is made of same material, such as silicon nitride (Si₃N₄). If the thickness of the color patterns is similar to that of the planar color pattern, the planar color pattern has maximum peak wavelength compared to that of the color patterns associated with the porous structure. Consequently, the peak wavelength can be further increased to 630 nm or more, such that the transmission spectra of FIG. 8 cover a wavelength range from 550 nm to 700 nm.

Therefore, the peak wavelength can be adjusted by changing the pitch P of the holes H2. In the present embodiment, when the thickness T2 of the patterned color layer (or the color patterns) ranges from 80 nm to 140 nm, the hole radius R ranges from 80 nm to 120 nm, and the pitch ranges from 200 nm to 300 nm, the wavelength of the transmission spectra of the color filter CF′ can range from 450 nm to 750 nm, so as to cover a wavelength range of visible light. Moreover, as the pitch of the color patterns of the patterned color layer becomes larger, the wavelength of the transmission spectra of the color patterns of the color filter CF will become lager. The pitch of one of the color patterns is positive proportional to corresponding wavelength of the transmission spectra of the one of the color patterns.

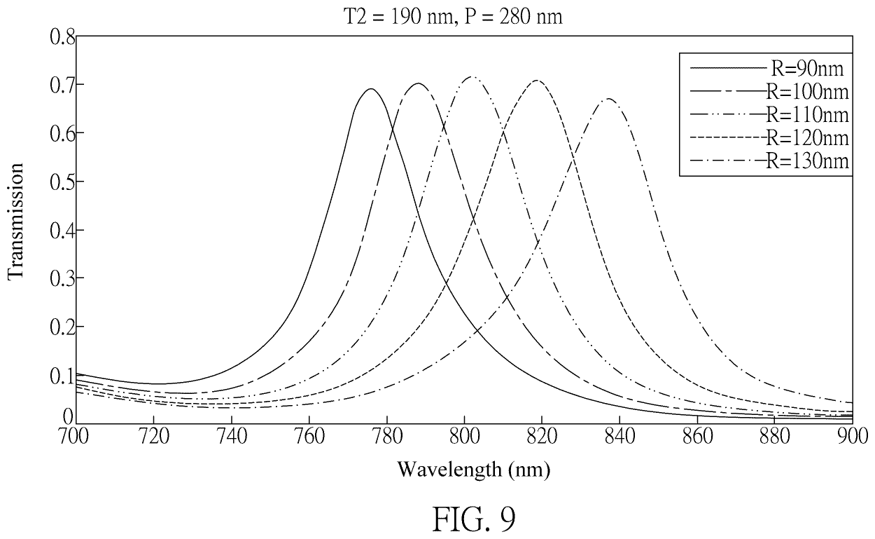

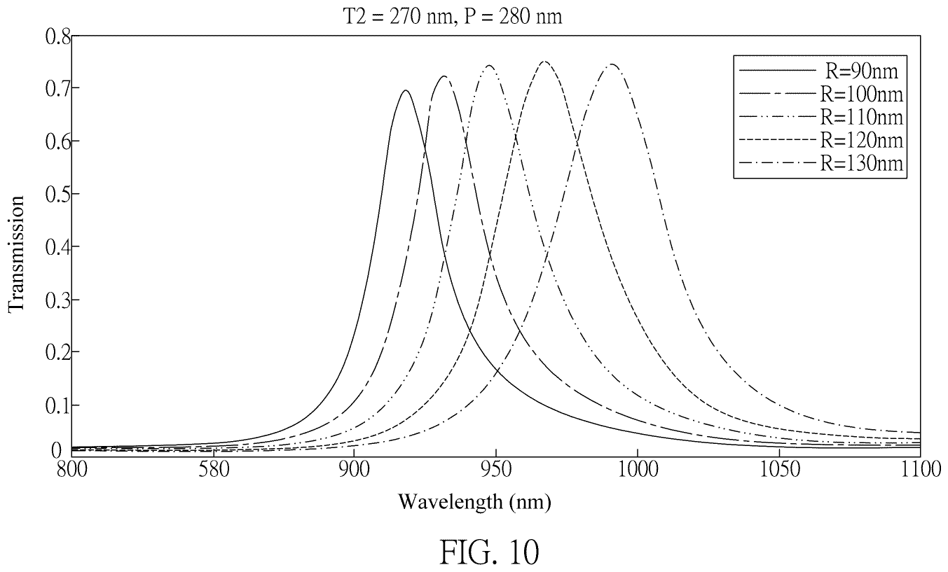

Reference can be made to FIGS. 9 and 10, which shows a third and a forth transmission spectra obtained by using a third and a forth exemplary structure of the color filter according to the second embodiment of the present disclosure. In the third and the forth exemplary structures of the color filters CF′, the patterned color layer 24 with only one of the color patterns 240, 241 and 242 is utilized for simulation, in which the thickness T2 of the patterned color layer 24 are 190 nm and 270 nm, respectively. In addition, the pitch P is 280 nm. Furthermore, the first reflective layer 22 and the second reflective layer 26 are DBR layers having the same thickness, e.g., 400-600 nm, and the substrate 20 is made of Si₃N₄. Furthermore, the porous structure of the patterned color layer 24 is made of silicon oxide, and the holes H2 are cylindrical holes filled with silicon nitride (Si₃N₄), thereby a refractive index of the porous structure being lesser than a refractive index of the material filled in the holes H2.

In a simulation scenario of FIGS. 9 and 10, an upper surface of the second reflective layer 26 serves as an incident surface and a lower surface of the substrate 20 serves as a transmission surface, that is, light is incident from the upper surface of the second reflective layer 26. As can been seen from FIGS. 9, as the hole radius R increases from 90 nm to 130 nm, a peak wavelength of each of the spectra increases from 770 nm to 850 nm (i.e., red-shifted), and the transmission spectra of FIG. 9 cover a wavelength range from 700 nm to 900 nm.

As can been seen from FIG. 10, as the hole radius R increases from 90 nm to 130 nm, a peak wavelength of each of the spectra increases from 910 nm to 990 nm (i.e., red-shifted), and the transmission spectra of FIG. 10 cover a wavelength range from 900 nm to 1100 nm. Moreover, since the DBR layers are utilized in the present embodiment, the color filter CF′ can be more selective, so as to achieve higher color purity.

Therefore, the peak wavelength can be adjusted by changing the hole radius R of the holes H2. In the present embodiment, when the thickness T2 of the patterned color layer (or the color patterns) ranges from 150 nm to 300 nm, the hole radius R ranges from 70 nm to 150 nm, and the pitch ranges from 250 nm to 300 nm, the wavelength of the transmission spectra of the color filter CF′ can range from 650 nm to 1150 nm, so as to cover a wavelength range of the near-infrared light. Moreover, the hole radius of the color patterns of the patterned color layer is larger, the wavelength of the transmission spectra of the color patterns of the color filter CF′ will be lager. The hole radius R of one of the color patterns is positive proportional to corresponding wavelength of the transmission spectra of the one of the color patterns.

It should be noted that, conventional optical filters for a specific wavelength range (e.g., from 700 nm to 1100 nm) necessitate the use of multiple different film thicknesses. Each of these thicknesses corresponds to a unique mask step in the process. However, the methodology provided by the present disclosure offers a significant reduction in the number of mask steps required. This simplification not only streamlines the fabrication process but also has the potential to reduce associated costs, thereby enhancing the overall efficiency and cost-effectiveness of the production process.

### Third Embodiment

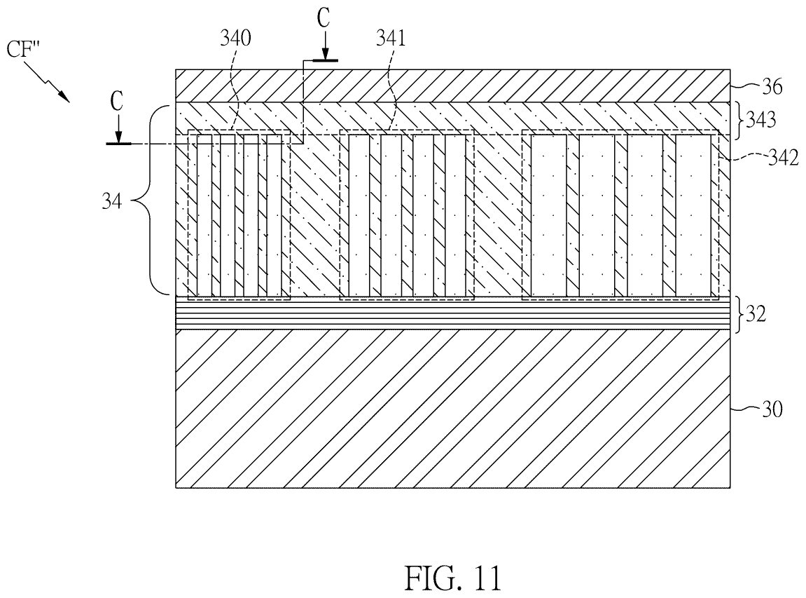

FIG. 11 is a schematic side view of a color filter according to the third embodiment of the present disclosure. Referring to FIG. 11, a third embodiment of the present disclosure provides a color filter CF″ that includes a substrate 30, a first reflective layer 32, a patterned color layer 34, and a second reflective layer 36. The substrate 30 can be made of a semiconductor material, such as silicon. The first reflective layer 32 is a DBR layer similar to the second embodiment.

The patterned color layer 34 is disposed on the first reflective layer 32, the patterned color layer 34 can include color patterns 340, 341 and 342 having the same or similar thickness T3, and each of the color patterns 340, 341 and 342 includes a porous structure having a plurality of holes H3 spaced from one another.

The patterned color layer 34 can be formed by sequentially performing deposition and patterning processes. In the deposition process, a flat layer made of a semiconductor material (such as SiNx) can be formed by using chemical vapor deposition (CVD). Preferably, the thickness of the flat layer (or the porous structure formed afterward) can range from 80 nm to 130 nm. It should be noted that, a refractive index of dielectric can be determined by the composition of the material, such as the nitrogen content in the SiNx film, and such the content can be continuously tuned by controlling deposition parameters. For example, a refractive index of the SiNx film can be varied from 2 to 3.1 by adjusting the gas flow rate during the deposition.

In the patterning process, the electron beam lithography (EBL) and reactive-ion etching (RIE) techniques can be utilized to form a plurality of cylindrical pillars, which are used to fill the holes H3 in the patterned color layer 34.

For forming a designated material (e.g., silicon oxide) to fill up spaces among the cylindrical pillars and to surround the cylindrical pillars, the inductively coupled plasma chemical vapor deposition (ICPCVD) can be utilized. During the filling process, in addition to deposition of the porous structure, a flatten layer 343 can be further formed on the porous structure. The flatten layer 343, as a part of the patterned color layer 34, can provide a flat surface for the second reflective layer 36. Preferably, the thickness of the flatten layer 343 can range from 5 nm to 30 nm. In the other word, the thickness of the flatten layer 343 can range from 10% to 20% of the thickness of the patterned color layer. Similarly, refractive indices of the porous structure and the flatten layer 343 can be determined by the oxygen content in the SiOx film, and such the content can be continuously tuned by controlling deposition parameters. For example, the refractive index of the SiOx film can be varied from 1.46 to 4.2 by adjusting the gas flow rate during the deposition. That is, by employing a dielectric film with tunable properties, a resonance condition can be met across a broader region, so as to achieve a wide range of colors as desired.

The second reflective layer 36 is then formed on the patterned color layer 34, to serve as a top reflector, and the second reflective layer 36 can be formed of a metal material with high reflectivity, such as silver, by using sputtering process. In some embodiments, a thickness of the second reflective layer 36 can be designed according to color spectra of the color filter CF″. In some embodiments, the thickness of the second reflective layer 36 can range from several nm to tens of nm, the present disclosure is not limited thereto. Preferably, the thickness of the second reflective layer 36 can range from 15 nm to 40 nm.

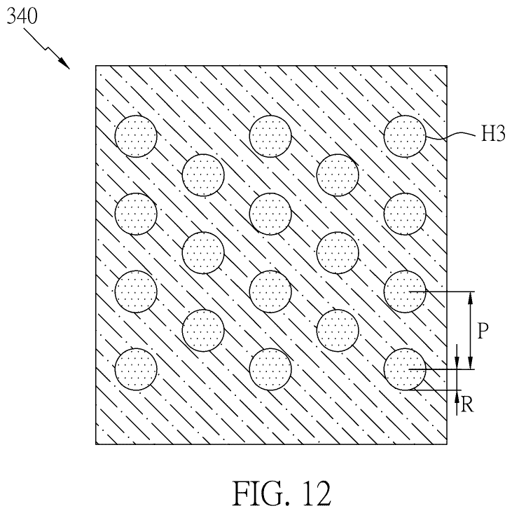

FIG. 12 is a schematic cross-sectional view taken along line C-C of FIG. 11. Referring to FIG. 12, the holes H3 are arranged in a hexagonal shape and filled with silicon nitride. In this embodiment, the hole radius R can range from 40 nm to 100 nm, and the pitch P can range from 200 nm to 300 nm. The thickness of the patterned color layer 34 which includes the flatten layer 343 can range from 100 nm to 160 nm.

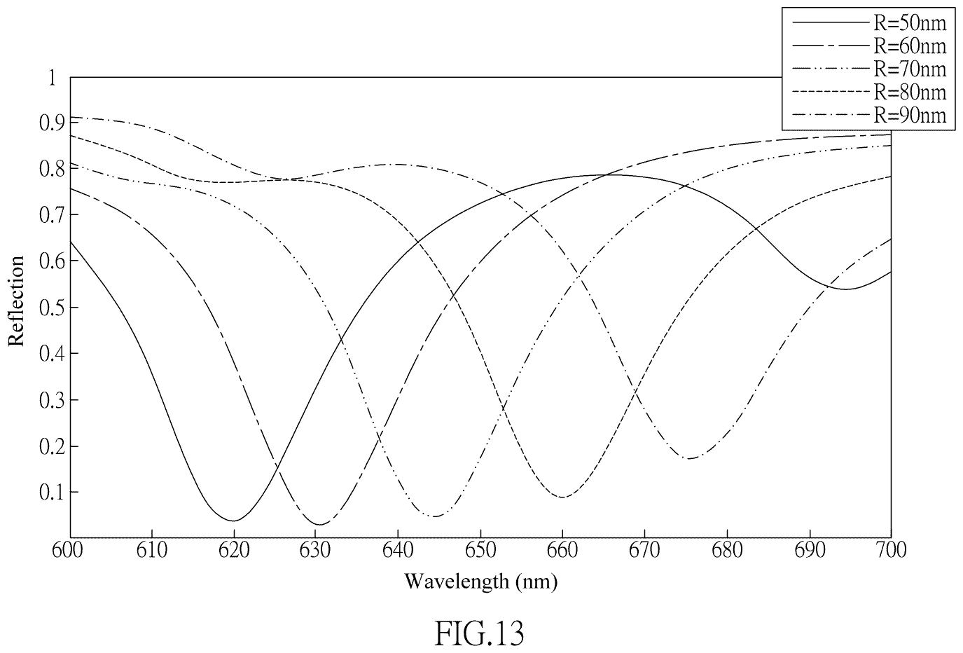

Reference can be made to FIG. 13, which shows a reflection spectra obtained by measuring reflectance of the color filter according to the third embodiment of the present disclosure for avoiding visible light absorption by substrate, especially taking silicon as the substrate. In the absence of losses, the reflectance, R should be 1-T.

As can been seen from FIG. 13, as the hole radius R increases from 50 nm to 90 nm, a peak wavelength of each of the reflection spectra increases from 620 nm to 675 nm (i.e., red-shifted), and the reflection spectra of 13 cover a wavelength range from 600 nm to 700 nm.

Therefore, by maintaining a constant thickness of the patterned color layer 34 and a fixed periodicity of the porous structure, the reflection dip is able to be adjusted by modifying the hole radius R of the nanostructure. This adjustment aligns with the trend observed in the simulation results mentioned in the second embodiments, thereby confirming the validity of the color filter provided by the present disclosure.

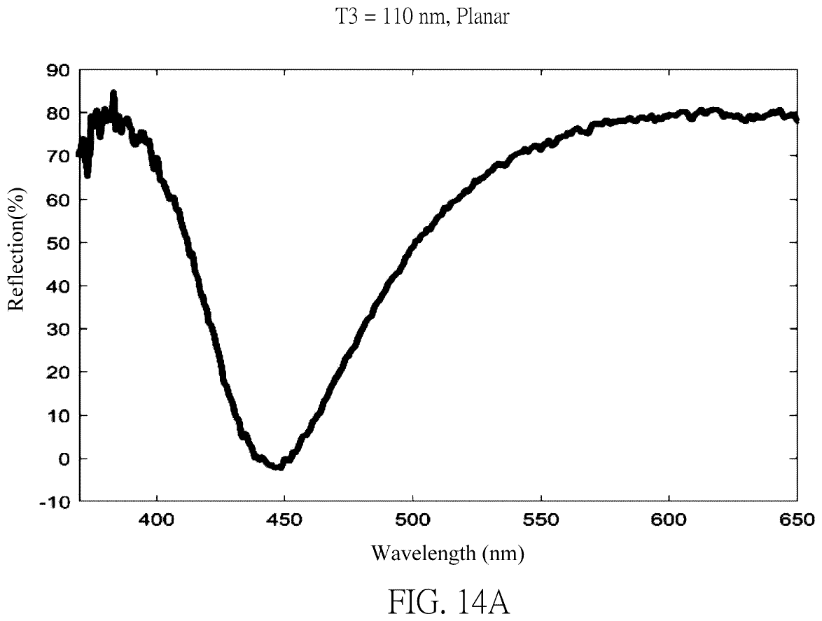

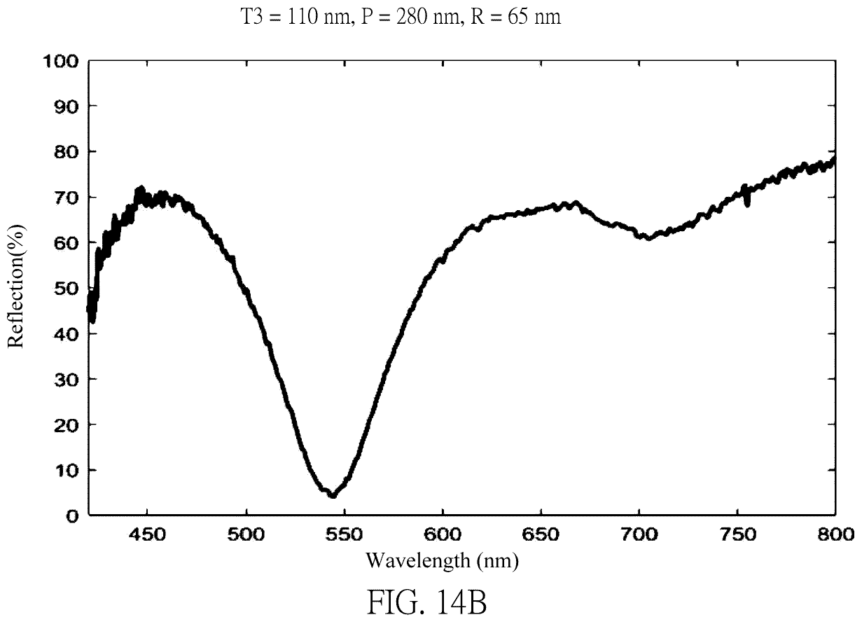

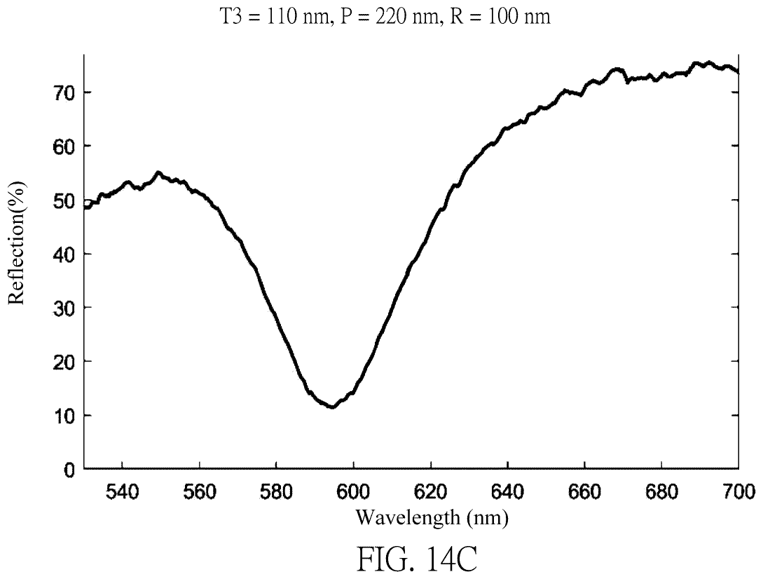

FIGS. 14A to 14C show reflection spectra of the color filter covering 450 nm to 600 nm according to the third embodiment of the present disclosure.

In some embodiments, one or more of the color patterns 340, 341 and 342 can be provided without a nanostructure and made of SiNx or SiOx. A peak wavelength of a reflection spectrum of the color pattern without the nanostructure can be an upper limit or a lower limit of a predetermined wavelength range, and the color patterns with the nanostructure respectively have reflection spectra with peak wavelengths within the predetermined wavelength range. For example, reference can be made to FIGS. 14A, the reflection spectrum of FIG. 14A is obtained by measuring the reflectance of the color filter CF″ of FIGS. 12 and 13 without nanostructure (i.e., planar color pattern), and a peak wavelength of the reflection spectrum of FIG. 14A is about 450 nm, which can be used as a lower limit of a predetermined wavelength range (>450 nm). In other embodiments, the peak wavelength of the reflection spectrum of the planar color filter can be about 650 nm, which can be used as an upper limit of the predetermined wavelength range (<650 nm). Furthermore, referring to FIGS. 14B, the reflection spectrum of FIG. 14B is obtained by measuring the reflectance of the color filter CF″ of FIG. 12, the thickness T3, the pitch P and the hole radius R are 110 nm, 280 nm and 65 nm, respectively. A peak wavelength of the reflection spectrum of FIG. 14B is about 550 nm, which is within the predetermined wavelength range. Moreover, the reflection spectrum of FIG. 14C is obtained by measuring the reflectance of the color filter CF″ of FIG. 12, and the thickness T3, the pitch P and the hole radius R are 110 nm, 220 nm and 100 nm, respectively. A peak wavelength of the reflection spectrum of FIG. 14C is about 600 nm, which is also within the predetermined wavelength range.

As can be seen from FIGS. 14A to 14C, the color filter CF″ provided by the present disclosure, which is designed based on nanopillar/nanohole structure, enables wavelength tunability from 450 nm to 650 nm.

It should be noted that, in previous embodiments (e.g., the first and second embodiments), one or more of the color patterns can be similarly provided without a nanostructure and made of SiNx or SiOx. A peak wavelength of a reflection spectrum of the color pattern without the nanostructure can be an upper limit or a lower limit of a predetermined wavelength range. For the color filter with the transmission spectra range from 650 nm to 1150 nm, the planar color pattern can be utilized to provide an upper limit and a lower limit for the predetermined wavelength range from 600 nm to 1200 nm, and for the color filter with the transmission spectra range from 700 nm to 1150 nm, the planar color pattern can be utilized to provide an upper limit and a lower limit for the predetermined range from 650 nm to 1200 nm.

### Beneficial Effects of the Embodiments

In conclusion, the color filter provided by the present disclosure can be fabricated without using multiple mask processes, so as to reduce the number of process steps and thus reduce costs and process complexity.

Furthermore, the wavelength range of the color filter provided by the present disclosure can be adjusted by modifying the thickness, the hole radius and the pitch of the nanostructure, so as to cover a wavelength range of different type of lights, such as the visible light and the near-infrared light.

Moreover, since the DBR layer(s) are utilized to serve as the top and/or bottom reflector, the color filter provided by the present disclosure can be more selective, so as to achieve higher color purity.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A color filter, comprising:
a substrate;
a first reflective layer disposed on the substrate;
a patterned color layer disposed on the first reflective layer, wherein the patterned color layer includes a plurality of color patterns having a first thickness, and each of the color patterns has a porous structure with a plurality of holes spaced from one another; and
a second reflective layer disposed on the patterned color layer,
wherein the porous structure includes a first material, the plurality of holes are filled with a second material, and hole dimensions of the plurality the color patterns are different from one another.

2. The color filter according to claim 1, wherein the plurality of color patterns corresponding to a plurality of lights with different wavelengths, and the first material has a first refractive index, and the second material has a second refractive index different to the first refractive index.

3. The color filter according to claim 2, wherein the plurality of holes of each of the color patterns are cylindrical holes that are arranged in a matrix or in a hexagonal shape.

4. The color filter according to claim 3, wherein the hole dimension of each of the color patterns includes a hole radius and a pitch between any neighboring holes, and the plurality the color patterns differ from one another in at least one of the hole radius and the pitch.

5. The color filter according to claim 1, wherein the patterned color layer further includes at least one planar color pattern without the porous structure, wherein the at least one planar color pattern is made of one of the first material and the second material.

6. The color filter according to claim 4, wherein the second refractive index is less than to the first refractive index, the hole radius of one of the color patterns is negative proportional to a corresponding wavelength of a transmission spectrum of the one of the color patterns.

7. The color filter according to claim 6, wherein, as the first thickness ranges from 140 nm to 200 nm, the hole radius ranges from 10 nm to 80 nm, and the pitch ranges from 140 nm to 200 nm, the plurality of color patterns are corresponding to wavelengths from 700 nm to 1150 nm.

8. The color filter according to claim 7, wherein the first reflective layer and the second reflective layer are made of a metal material and have a second thickness ranging from 5 nm to 30 nm.

9. The color filter according to claim 4, wherein the second refractive index is larger than to the first refractive index, the hole radius of one of the color patterns is positive proportional to a corresponding wavelength of the reflection/transmission spectra of the one of the color patterns.

10. The color filter according to claim 9, wherein each of the color patterns further includes a flatten layer disposed on the porous structure, and the flatten layer includes the first material.

11. The color filter according to claim 10, wherein, as the first thickness ranges from 100 nm to 160 nm, the hole radius ranges from 40 nm to 100 nm, and the pitch ranges from 200 nm to 300 nm, the plurality of color patterns are corresponding to wavelengths from 600 nm to 700 nm.

12. The color filter according to claim 10, wherein the thickness of the flatten layer ranges from 10% to 20% of the thickness of the patterned color layer.

13. The color filter according to claim 9, wherein the first reflective layer is a distributed Bragg reflector layer that includes a plurality of pairs of a first layer having a third refractive index and a second layer having a fourth refractive index, and the second reflective layer is made of a metal material and a quantity of the pairs of the first layer and the second layer included in the distributed Bragg reflector layer ranges from 2 to 5.

14. The color filter according to claim 13, wherein, as the first thickness ranges from 80 nm to 130 nm, the hole radius ranges from 40 nm to 100 nm, and the pitch ranges from 200 nm to 300 nm, the plurality of color patterns are corresponding to wavelengths from 450 nm to 600 nm.

15. The color filter according to claim 4, wherein the second refractive index is less than to the first refractive index, the pitch of one of the color patterns is positive proportional to a corresponding wavelength of the transmission spectra of the one of the color patterns.

16. The color filter according to claim 15, wherein, as the first thickness ranges from 80 nm to 140 nm, the hole radius ranges from 80 nm to 120 nm and the pitch ranges from 200 nm to 300 nm, and the plurality of color patterns are corresponding to wavelengths ranging from 450 nm to 750 nm.

17. The color filter according to claim 9, wherein the first reflective layer and the second reflective layer are made of distributed Bragg reflector layers, and the first thickness ranges from 150 nm to 300 nm and the hole radius ranges from 70 nm to 150 nm and the pitch ranges from 250 nm to 300 nm, the plurality of color patterns are corresponding to the wavelengths range from 650 nm to 1150 nm.

18. A color filter, comprising:
a first reflective layer;
a first color pattern, a second color pattern, and a third color pattern disposed on the first reflective layer; and
a second reflective layer disposed on the first color pattern, the second color pattern and third color pattern;
wherein the first color pattern has a first nanostructured structure corresponding a first peak wavelength of a reflection spectrum, the second color pattern has a second nanostructured structure corresponding a second peak wavelength of the reflection spectrum, and the third color pattern corresponding a third peak wavelength of the reflection spectrum without a nanostructured structure, the first nanostructured structure and the second nanostructured structure are different, the first peak wavelength, the second peak wavelength, and third peak wavelength are different, the first peak wavelength and the second peak wavelength are within a predetermined wavelength range, and the third peak wavelength is an upper limit or a lower limit of the predetermined range.

19. The color filter according to claim 18, wherein the first nanostructured structure has a plurality of first holes spaced from one another, and the second nanostructured structure has a plurality of second holes spaced from one another;
wherein, the first nanostructured structure includes a first material, the plurality of first holes and the plurality of second holes are filled with a second material which is different to the first material.

20. The color filter according to claim 19, wherein, when a second refractive index of the second material is larger than a first refractive index of the first material, a hole radius of the first color pattern is larger than a hole radius of the second color pattern, and the first peak wavelength is larger than the second peak wavelength, and
wherein, when the second refractive index is less than the first refractive index, the hole radius of the first color pattern is less than the hole radius of the second color pattern, or a pitch of the first color pattern is larger than a pitch of the second color pattern, and the first peak wavelength is larger than the second peak wavelength.
